(19) United States
(12) Patent Application Publication
(10) Pub. No.: US 2017/0278173 A1
(43) Pub. Date: Sep. 28, 2017

(54) PERSONALIZED BUNDLE RECOMMENDATION SYSTEM AND METHOD

(71) Applicants: International Business Machines Corporation, Armonk, NY (US); Massachusetts Institute of Technology, Cambridge, MA (US)

(72) Inventors: Markus R. Ettl, Ossining, NY (US); Arun Hampapur, Norwalk, CT (US); Pavithra Harsha, White Plains, NY (US); Anna M. Papush, Somerville, MA (US); Georgia Perakis, Belmont, MA (US)

(21) Appl. No.: 15/080,759

(22) Filed: Mar. 25, 2016

(51) Int. Cl. G06Q 30/06; G06Q 10/08

(52) U.S. Cl. CPC G06Q 30/0631; G06Q 10/087

(57) ABSTRACT

An aspect of the disclosure includes a method, a system and a computer program product for determining a personalized bundle offer for a consumer. The method includes determining an interest in an initial product by a consumer. A demand group is identified based on the initial product. A purchase probability is determined for the consumer to purchase the product. An inventory expected profit-to-go is determined for the product. At least one additional product from the demand group is determined based at least in part on the purchase probability and the inventory expected profit-to-go, the expected profit to go being based on a current inventory state of the product and the at least one additional product. A signal is transmitted to the consumer, the signal including at least one additional product and a price for a bundle containing both the product of interest and the at least one additional product.

### BACKGROUND

The present invention relates generally to a system and method for offering goods and services to a consumer, and in particular to a system and method of offering personalized bundles of goods or services to a consumer based on a current interest.

Merchants or retailers offer a vast variety of goods and services to consumers. Some customers often prefer online shopping as it due to the fact that it offers a simple way of reviewing and purchasing items they desire with less effort than a physical purchase of the same item from a retail establishment. Furthermore, online merchants offer a diverse assortment of goods and services, allowing the consumer to purchase what they need from a single online source. Merchants, whether online or in a physical location, may identify and offer discounts based on bundles of items that the merchant groups together in an attempt to increase the sales to the customer.

### SUMMARY

Embodiments include a method, system, and computer program product for determining a personalized bundle offer consisting of a combination of products to a consumer. The method including determining by a computing device an interest in an initial product by a consumer. A demand group is identified by a computing device based on the initial product. A purchase probability for the consumer is determined by the computing device to purchase the initial product. An inventory expected profit-to-go is determined by the computing device for the initial product. At least one additional product from the demand group is determined by the computing device based at least in part on the purchase probability and the inventory expected profit-to-go, the expected profit to go being based at least in part on a current inventory state of the initial product and the at least one additional product. A signal is transmitted by the computing device to the consumer, the signal including at least one additional product and a price for a bundle containing both the initial product of interest and the at least one additional product.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a cloud computing environment according to an embodiment;

FIG. 2 depicts abstraction model layers according to an embodiment;

FIG. 3 depicts a flow diagram of a method for creating a personalized bundle of goods or services for a consumer in accordance with some embodiments;

FIG. 4 depicts a flow diagram of a method for determining the personalized bundle to be offered; and

FIG. 5 depicts a flow diagram of a method for estimating inventory function values.

### DETAILED DESCRIPTION

Embodiments of the present disclosure provide for a system and method for determining a personalized bundle offer consisting of a combination of products to a consumer. Embodiments herein provide for determining the combination of products based at least in part on a real-time determination of “non-anonymous” or individualized expected profit for the combination of products, which is selected from a demand group by using individually personalized propensity to pay models. Embodiments herein provide for a determination of the combination of products based at least in part on the value of inventory, which is calculated using parameters that are updated on a periodic or aperiodic basis as well as the current inventory levels in real-time.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as Follows:
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

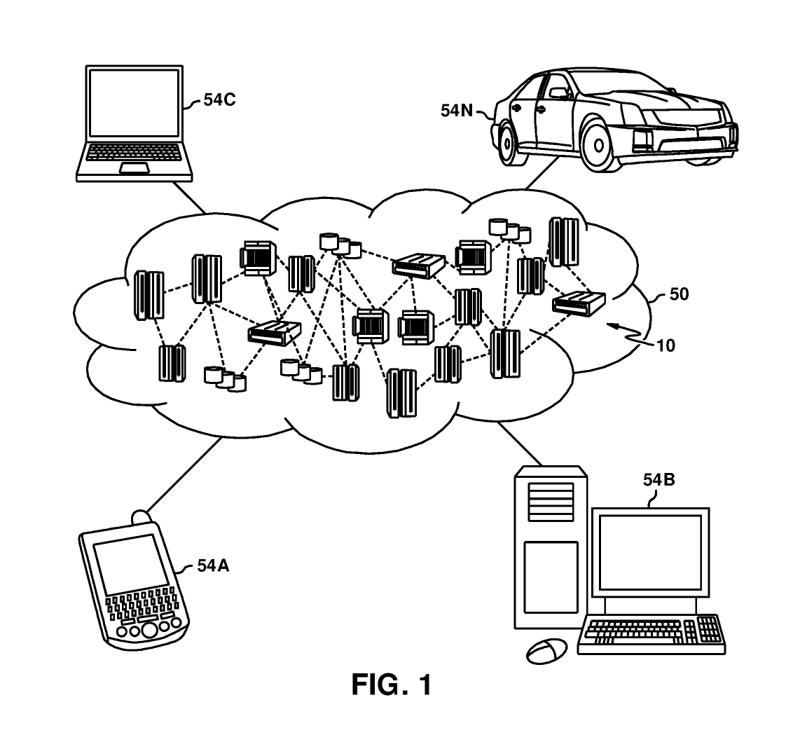

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

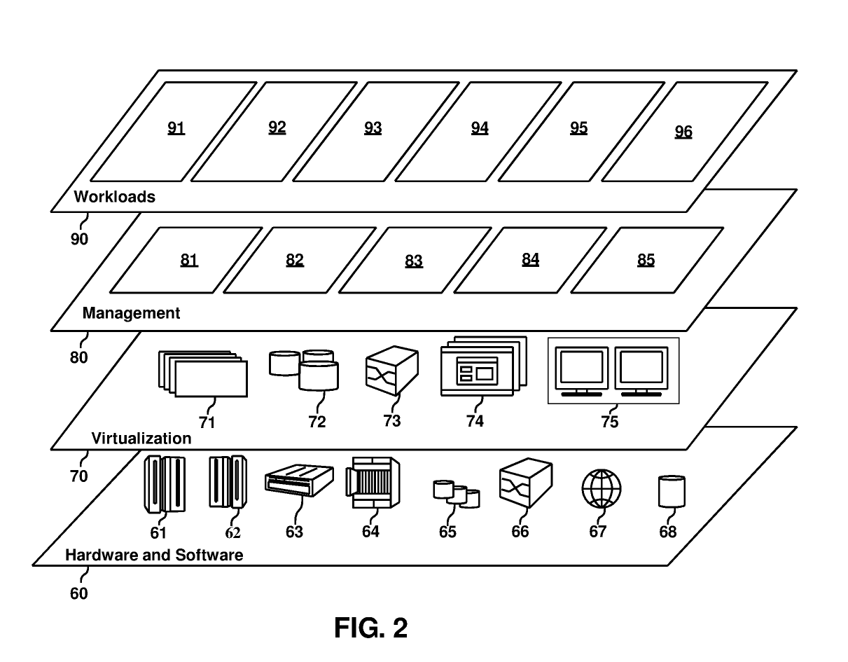

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

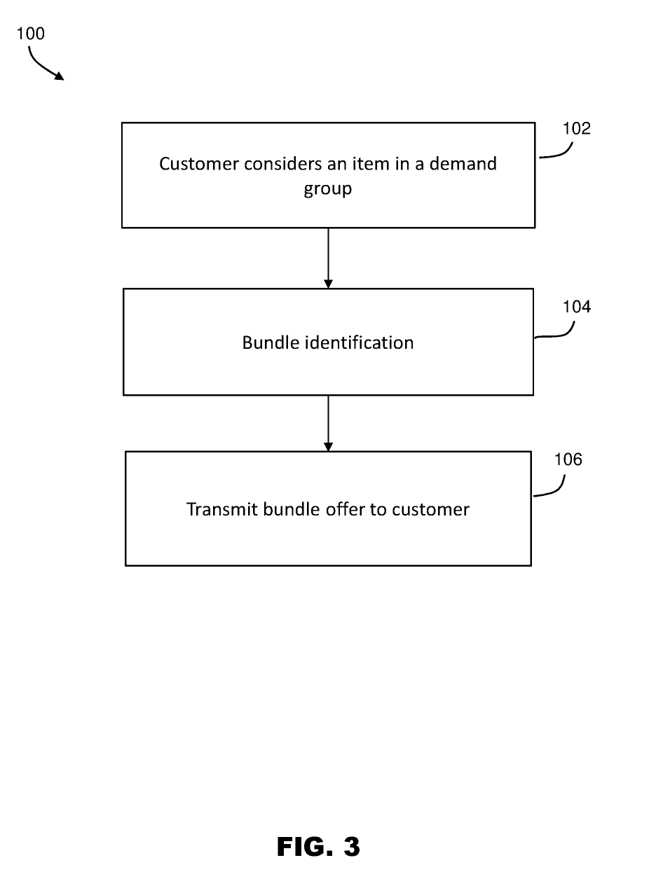

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and a personalized product bundle processing 96. The personalized product bundle processing 96 may perform one or more methods that allow for the collection of information about participants and matching of the participant's interests with those of an interest group, such as but not limited to the methods described in reference to FIGS. 3-5 for example.

Referring now to FIG. 3, an embodiment is shown of a method 100 for determining an offer for sale of a combination of products to a consumer. The method 100 starts in block 102 where a node 10 determines that a consumer is interested in a product. In an embodiment, the determination of the consumer interest may be based on the consumer receiving information from a merchant, such as the consumer directing their personal computing device 54A, 54B, 54C to a webpage operated by the online merchant for example. In one embodiment, the determination of consumer interest may be based on the consumer performing online searches, either in the merchant's node or through a general search engine for example.

In an embodiment, the product of interest may be associated with other products to form a demand group. A demand group is a group of associated goods that are often or commonly purchased together. A demand group may be based on historical purchasing transaction data. It can also be based on a possible predictable future trend. In one embodiment, the demand group may be predetermined prior to the consumer's interest in the product. In another embodiment, the demand group may be further based on contextual information, such as the consumer demographics, consumer social media activity or consumer geographic location information for example. In an embodiment, the consumer may be assigned to a segment group based on demographic information, purchase history, and consumer loyalty information (e.g. brand preferences of consumer). The demand group may be further based on the segment of the consumer showing interest in a product.

It should be appreciated that while embodiments herein may describe the demand group as including a group of discrete or particular items, this is for exemplary purposes and the claimed invention should not be so limited. In other embodiments, the demand group may include categories of goods or services that the consumer may choose from. For example, when a consumer shows interest in a product A (e.g. pants), the demand group include any of the items in a product B category (e.g. shirts).

After determining the consumer interest in a product and the associated demand group, the method 100 proceeds to block 104 where a group of products, sometimes colloquially referred to as a “bundle,” are identified. In the exemplary embodiment, the bundles are selected from the demand group and include at least the initial product of interest. As discussed in more detail herein, the selection of the bundle of products is based at least in part on an inventory expected profit-to-go value for each of the products in the bundle (estimated over a given time horizon), as well as an individual purchase probability parameter. It should be appreciated that this allows for the leveraging of the value of left over inventory of all the items in the demand group. For example, items with excess inventory which are at risk of steep impending markdowns may be prioritized for bundling. For items in the demand groups that are non-perishable items or services in which case, the concept of inventory is less meaningful; this expected profit is just the return from offering of that item till the end of the given horizon. In an embodiment, the estimation parameters for the value of inventory are determined on a periodic or aperiodic basis (e.g. every 15 minutes, 30 minutes or 1 hour), and then used in real-time or near real-time to make a bundle offer to a consumer. In the exemplary embodiment, the estimation parameters for the value of inventory are determined on a periodic basis of less than 5 minutes.

It should be appreciated that a plurality of bundles may be identified. In an embodiment, a first bundle of the plurality of bundles is selected based at least in part on determining the expected profit for the combination of the initial product of interest with at least one additional product from the demand group, including estimation of the current inventory-at-risk parameters. In an embodiment, the current inventory-at-risk parameters are determined using a fixed markdown ladder methodology. As used herein a markdown ladder or pricing ladder may be a schedule of prices used by the seller (e.g. the online merchant). A periodic review of these parameters may be performed based on a schedule of dates when the seller commences the markdown (e.g. reduction or discount) of prices.

The selection of the first bundle may be further based on the purchase probability that the consumer who is interested in the initial product will purchase the bundle of products. In an embodiment, the purchase probability parameter is the product of a segment-level purchase probability parameter (e.g. probability for a group of people similar to the consumer) and a confidence parameter. In an embodiment, the segment-level purchase probability parameter is based at least in part on a generic or general population propensity to pay function (e.g. 25% of the general population purchase product X at $24.99) combined with the consumers demographic and loyalty information (e.g. Age 25-30, frequent shopper). The confidence parameter may be determined based on context (e.g. how the consumer expressed interest, on online merchant site or through general search engine), in-session information (e.g. how long have they been on the product page, what is their intent), and social media information. In an embodiment, the purchase probability parameter is based at least partially on a parametric consumer model of choice, such as an MNL model for example.

After the first bundle has been selected, the method 100 proceeds to block 106, where a signal is transmitted to the consumer. In an embodiment, the signal includes bundle data such as but not limited to a list of products being combined together as an offer, a personalized price at which the combination of products is offered, and the amount of savings the consumer may realize if the bundle offer is accepted and a purchase is made. As discussed above, the list of products can also be list of categories of products over which the discount is provided for example (pick one item each from each of the categories in the bundle). In one embodiment, the signal is displayed on the consumers computing device 54A, 54B, 54C such as on the online retailer or merchant webpage for example. In another embodiment, the signal is transmitted to the consumer via an e-mail, a cellular text message, an online electronic message or via a social media application. In still other embodiments, the signal may be transmitted via a kiosk positioned in a physical retail location or in an application executed on the consumer's mobile device.

It should be appreciated that while embodiments herein describe the selection of an optimal personalized bundle, this is for exemplary purposes and the claimed invention should not be so limited. In other embodiments, the method 100 may transmit a signal including a plurality of bundles to offer to the consumer. In still further embodiments, the plurality of bundles may be presented to the consumer in a ranked listing.

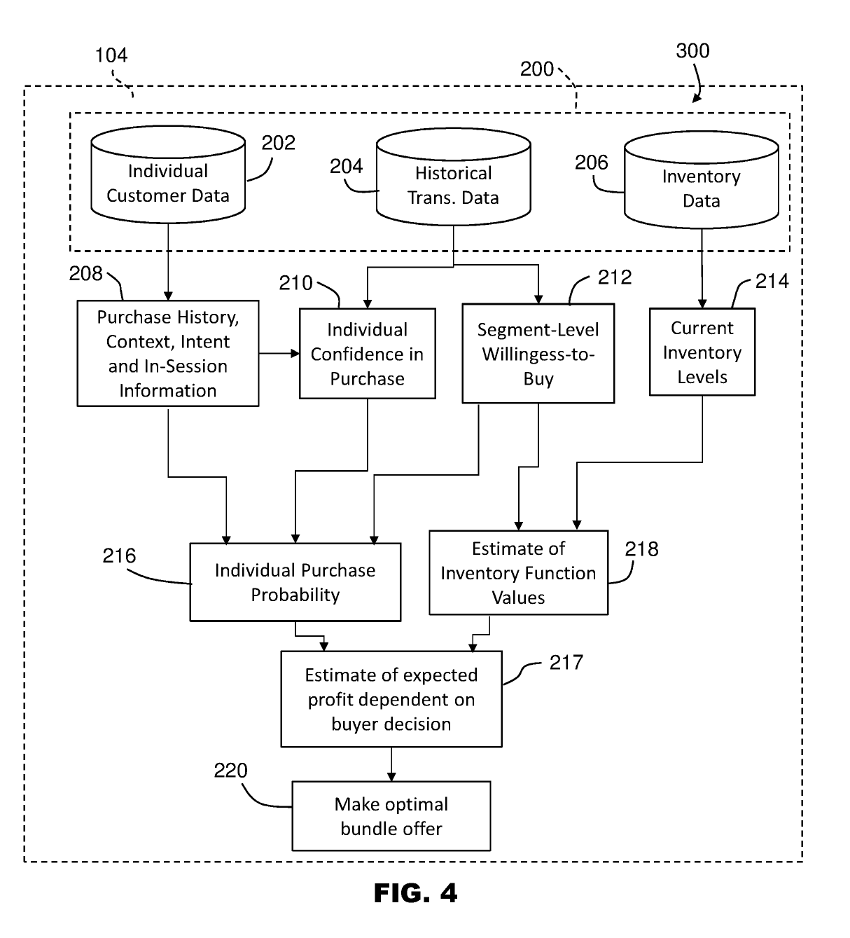

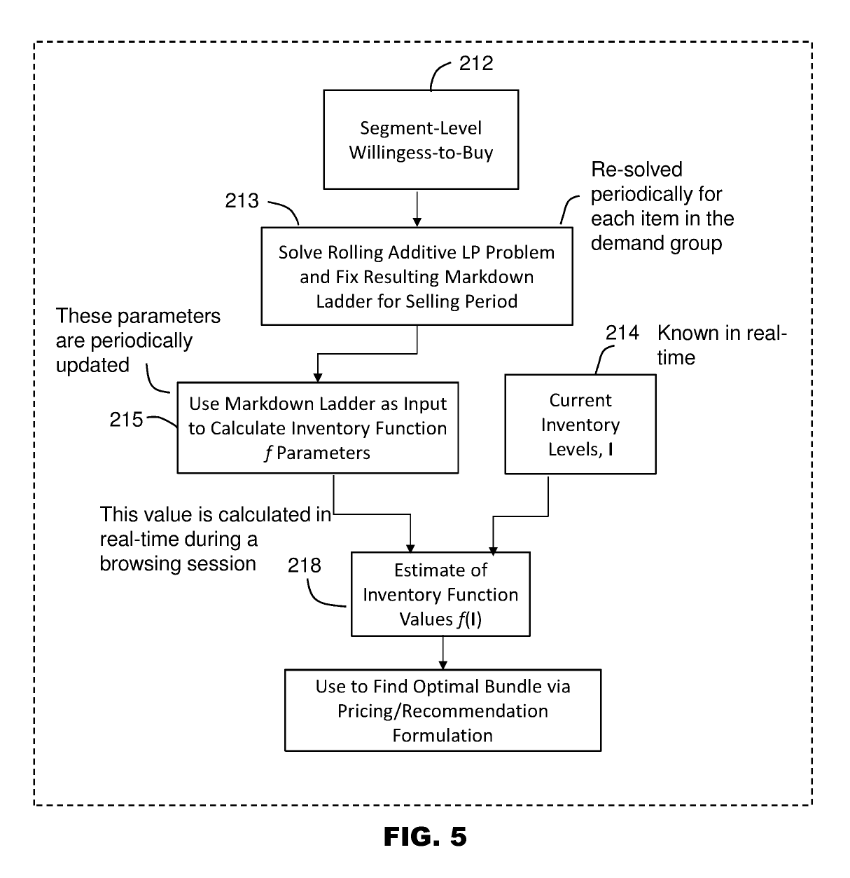

Referring now to FIG. 4, another embodiment of the identification of the first bundle determined in block 104. In this embodiment, the method 300 starts by receiving data in block 200. The data may be received from different sources or a single source. The data may include individual customer data 202, historical transaction data 204 and inventory data 206. Individual customer data 202 may include, but is not limited to, information on the consumer such as historical transactions, demographics, social media data, as well as in session information for example. The historical transaction data 204 includes, but is not limited to, general population data related to the product the consumer is interested in, such as but not limited to, demographic information, historical transaction data (that includes sales, prices, promotion information, time effects), and loyalty/brand information. The inventory data 206 includes, but is not limited to, data such as quantities of the product, cost-basis for the product, product aging, and a price markdown schedule for example.

From the individual customer data 202, data such as the purchase history of the individual and contextual information about the individual are received and aggregated in block 208. Contextual information may include information such as other webpages that were recently visited, Internet search terms recently used, and messages or information (e.g. likes, shared posts, etc.) transmitted via social media. In session information can include, but is not limited to, the time they spent on the item or the information provided in the interaction with the retailer. As discussed in more detail herein, the individual customer data is used in the determination of purchase probabilities for proposed bundles.

From the historical transaction data 204 association rules and confidences may be determined in block 210 and segment level purchase probabilities may be determined in block 212. As used herein, association rules and confidences are conditional probabilities based on general population data and individual context. In an embodiment, association rule models extract associations from historical sales or transaction data by identifying frequent items sets within the data and building confidences of purchase from these sets. In an embodiment, association rule mining may be performed using machine learning methods. As discussed in more detail herein, when the conditional probabilities of confidence of the future purchase of an item are multiplied by the willingness to pay for that item, the estimation of a personalized demand may be determined. As used herein, the segment level purchase probabilities 212 are estimated based on a clustering of the consumers from the general population based on purchase history, shopping context and social media knowledge, creating groups of shoppers with similar preferences similar purchase backgrounds.

From the inventory data 206, data related to current inventory levels 214 is extracted. In an embodiment, the inventory data for items within a demand group may be determined at an initial time that occurs prior to the consumer expressing interest in an item. The inventory data is extracted on a continuous or near-continuous (periodic) basis. As will be discussed in more detail herein, an inventory expected profit-to-go over a specified horizon will be estimated from the inventory data. The parameters of this expected profit-to-go function will then be assumed constant for a small period of time.

The data on the individual 208, the association rules and confidences 210 and segment-level purchase probabilities 212 flow to block 216 where the purchase probability of the individual is determined. As discussed herein, this demand estimation may be bifurcated into static and dynamic components. The static components include parameters originating from methods such as traditional demand estimation, for example a choice model such as a multinomial logit model. The static components are determined in advance using offline estimation methods on historical consumer transaction data. The dynamic components, in contrast, are determined in real-time or near real-time, such as at the point when the customer expresses interest in an item during an online browsing session. Thus the dynamic components may be determined instantaneously in order to identify and offer the bundles as the consumer shops.

Similarly, the segment-level purchase probability 212 and the current inventory levels 214 data flow to block 218 where an estimate of the inventory expected profit-to-go over a specified horizon is determined. The expected profit-to-go block 218 together with the immediate expected profit from a transaction with the buyer obtained from individual purchase probability block 216, provide an estimate of the total expected profit while taking into account inventory balancing. In an embodiment, this determination is an estimate based on a heuristic that approximates the inventory expected profit-to-go. It should be appreciated that in an embodiment, the estimated total expected profit seeks to balance inventory and profit by considering current inventory levels so that when combined with demand estimates, items may be bundled to both increase/maximize sales through the end of the time horizon while reducing or minimizing inventory-related losses resulting from both salvaging excess inventory and stock outs. In an embodiment, the method attempts to balance the increase in sales of products while also reducing or eliminating discounts on popular products that could be sold (within the sales horizon) with no or little discount.

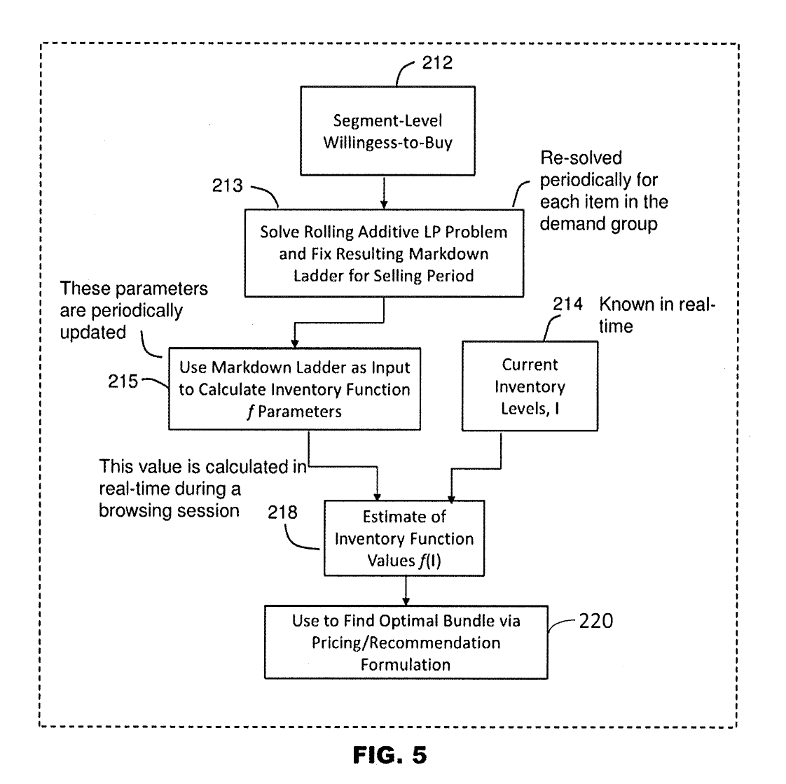

In an embodiment the steps performed in blocks 212-218 may be as shown in FIG. 5. In this embodiment, the method starts at block 212 where it is determined that a segment-level willingness-to-buy or segment-level purchase probability is determined. The method then proceeds to block 213 where a rolling additive linear programming problem is solved and the resulting markdown ladder is fixed or remains constant for the selling period. This solving of block 213 is re-solved on a periodic or aperiodic basis for each item in the demand group. The method then proceeds to block 215 where the markdown ladder is used as an input to determine inventory function ƒ parameters. The inventory function ƒ parameters are determined on a periodic or aperiodic basis. The method then proceeds to block 218 where the estimate of the inventory function values ƒ (I) is determined based on the inventory function ƒ parameters and the current inventory levels. The current inventory levels I may be determined in real-time or near real-time. The estimate of the inventory function values ƒ(I) may then be determined continuously, in real-time or near real-time during a browsing session by a consumer.

The method then proceeds to block 220 where the bundles of items are determined based on the individual purchase probability and the estimated inventory expected profit-to-go. In an embodiment, the bundles are determined using the following price and bundling recommendation model:

maximize
SₖεŜ,p_{S}_{ₖ} [symbol] _{S}_{ₖ}^{k}(p_{S}_{ₖ})[p_{S}_{ₖ}−c_{S}_{ₖ}+ƒ(I−e_{S}_{ₖ})]+Σᵢφᵢ^{k}(p_{S}_{ₖ})[p̅ᵢ−cᵢ+ƒ(I−eᵢ)]+ [symbol] ^{k}(p_{S}_{ₖ})ƒ(I) [symbol] [symbol]
ubjec [symbol] o [symbol] _{S}_{ₖ} [symbol] ≦p_{S}_{ₖ} [symbol] k,SₖεŜ [symbol]
(1−ε)p̅_{S}_{ₖ} [symbol] ≦p_{S}_{ₖ} [symbol] k,SₖεŜ [symbol]
p_{S}_{ₖ} [symbol] ≧p_{S}_{ₖ} [symbol] k,SₖεŜ

Where data parameters (input parameters) include:
Ŝ is a demand group; related items whose demands depend on the prices of others, in an embodiment, this set may include both frequent and infrequent items;
kεK is the type of customer segment, in an embodiment this is a function of preferences, context and demographic information. While the word type used in this disclosure to define each k, it is noted that the set of types K can be infinite in practicality as each type encompasses an individual's loyalty value (which may be the same as another customer), but also personalized information such as social media context, purchase history and demographic information, which when coupled together will rarely result in two customers belonging to the same type k. Thus the type k is essentially on an individual level as opposed to segment level;
p̅_{S} is the nominal price of bundle S (or product i) as a scalar value, p̅_{S}= [symbol] _{iεS}p̅ᵢ;
φ_{S}_{ₖ}^{k}(p_{S}_{ₖ}) is the probability that a customer of type k will purchase a bundle Sₖ when offered at a price p_{S}_{ₖ};
φ̅^{k}(p_{S}_{ₖ}) is the probability that a customer of type k will not purchase anything when offered a bundle Sₖ;
I [symbol] s the inventory of all items (SKU's) at a time a recommended bundle is offered, in an embodiment I is a vector representing a state of the system;
e_{S} is a bundle (or a single product) unit vector that is 1 for all iεS and 0 otherwise; and
c_{S} is a scalar quantity that is given by the vector product c^{T}e_{S} where c^{T} is the transpose of the vector of costs, where each entry corresponding to iεS is equal to cᵢ.

The decision variables or outputs from the price and bundling recommendation model include:
Sₖ, which is the bundle recommended to consumer type k; and
p_{S}_{ₖ}, which is the personalized price of the recommended bundle for consumer type k.

Briefly, the price and bundling recommendation model seeks to increase or maximize the revenue to the retailer by choosing a bundle (or single item) and corresponding price for each consumer type k, while taking into account the expected value-to-go function ƒ of the inventory for future selling time periods. A first constraint places a lower bound on the bundle (or item) price for each consumer type k by the sum of the costs of all products in the bundle. In other words, it would not be desirable to discount the bundle to the point of a loss in revenues (with prices falling below procurement costs). A second constraint places a boundary that the bundle (or item) price will not fall below a 100% decrease from the nominal price p̅. In an embodiment this constraint may be neglected during the determination (ε=1), but may be useful in some embodiments for a retailer with limitations in discount range. Finally, the last constraint is the reverse of the previous constraint in that it supports profitability and prevents the recommended bundle price from exceeding the sum of the nominal prices of all items in the bundle (the same applies to recommendations of single items).

In an embodiment, to effectively capture personalization, the price and bundling recommendation model is determined for each consumer type k separately.

It may be observed that there are two sets of terms in the bundling and pricing model: one set is responsible for expected profitability while the other accounts for approximating the value of the current inventory-at-risk estimation for markdown. For the purposes of discussion here, we assume that ƒ is some function that is provided to us. How we arrive at estimating function ƒ is described in more detail herein. It should be appreciated that for both the profit and inventory terms the objective function incorporates summations for both the items in the bundle S and the rest of the items in the demand group, which is due to the situation where consumers may decline the bundle offer but still purchase individual items (or may make no purchase at all).

Embodiments provide for the determination of recommended bundles (or items) for each consumer type k independently during time period t, thus providing personalization for each shopper. It should be appreciated that this may result in the computational difficulty of quickly finding the values for the ƒ functions as the inventory updates dynamically throughout each time period. If the forward-looking function is explicitly determined for each consumer using a dynamic programming formulation, the computational cost is too large to provide real-time or near real-time recommendations. As is discussed in more detail herein heuristic approaches are used to resolve the computational challenges.

Traditional demand functions capture consumer demographic information, historical preferences and loyalty information through standard distributions such as the multinomial logit. However, an accurate estimation of willingness-to-pay based on detailed purchase history is extremely challenging due to the combinatorially explosive number of subtrees. Instead of dealing with this computational issue, a two-part demand modeling approach is used containing static and dynamic components that may be combined in order to achieve a personalized willingness-to-pay estimate in real-time. The initial step is referred to as “static”, in that it consists of traditional demand estimation using an approach such as the multinomial logit model. This estimation step results in a demand model based partially on customer segments (for parameters related to features such as loyalty), and its parameters are calculated offline (e.g. at a point of time prior to the consumer being interested in the item, in other words not in real-time). The parameter estimation is calculated for the population as a whole based on transaction data, and may be regularly adjusted throughout the selling horizon (e.g. a predetermined time period). Between such updates it is assumed the parameter values remain constant. Thus, this willingness-to-pay static component but based on personalized consumer characteristics.

Having calculated the customer preference distributions denoted by φ^{k}(p) [symbol] which depend on offered price p), a dynamic step in the form of a combination between personalized demand and association rules may be determined. In this second step of the demand estimation, a consumer of types kεK (where the explanation of type is explained previously in the disclosure) shows interest in a product and their respective purchase history, shopping context and social media knowledge is realized. The pre-calculated demand function (with fixed known parameters) is populated with this consumer's individual values for each feature in the demand model, and then further scale this estimation by incorporating purchase history. By considering groups of consumers with similar preferences (willingess-to-pay distributions), purchase histories, context and in-session intent, a demand scaling in form of association rules may be calculated. Given that association rules are essentially conditional probabilities, the confidence Cᵢ^{k} of a future purchase of item i may be dynamically multiplied with the willingness-to-pay estimation φᵢ^{k}(p) to create a more personalized demand estimation for each consumer of type k. Thus, a scaled willingness-to-pay estimation is constructed that is personalized, in the form of, φᵢ^{k}(p)=φᵢ^{k}(p)·cᵢ^{k}. After observing each arrival during time period t this willingness-to-pay estimation reasonably updates the inventory by one unit from one consumer to the next. Furthermore, as there are many methods (e.g. Apriori and FP-growth) for computationally efficient calculation of frequent item sets, the purchase histories, in session intent and context, may be updated dynamically and thus update the demand model by altering Cᵢ^{k}.

Before the recommended bundle, bundles or items can be determined and offered to the customer, the inventory to go portion (block 218, FIG. 4) needs to be determined so that profits may be increased/maximized and while balancing inventory. As the inventory function ƒ is forward-looking to periods t+1, t+2, . . . , T, the determination of the expected profit (block 217, FIG. 4) may be computationally challenging. To approximate the value-to-go function from the pricing formulation heuristic approximations may be use to estimate the inventory expected profit-to-go in a computationally reasonable amount of time.

The inventory function ƒ(I) is a measure of the expected future profit given the current level of inventory for all the remaining selling periods until the end of the horizon. For example, for a seasonal item, this function balances the expected future consumer arrivals in all periods going forward, as well as the markdown ladder schedule for the remainder of the selling horizon. Consequently, for non-seasonal, non-perishable items or services, ƒ(I) is set to 0 where the time horizon is just the current period else the expected profit from the offering each period when T is longer than the current period. In some embodiments, the goal of building it into the objective function for a seasonal item is to prioritize bundling products with excess inventory and impending steep discount periods. Thus, a high value of ƒ(I) corresponds to a bundle containing products that are at a high risk/probability for markdown (discount) and are currently occupying warehouse space. By contrast, low values of ƒ(I) indicate products that are selling well and have a low probability of deep discounts in the near future. A value of ƒ(I)=0 indicates that the inventory of a given product (or bundle) has been entirely depleted, or is at such a low level (given the time remaining) that there are no anticipated future sales by the end of the selling horizon. It also refers to the case when inventory levels have no meaning and the item\service is largely available. It should be appreciated that in some embodiments the goal of this function is to incorporate inventory and markdown effects into the bundle selection and pricing process in order to capture future demand as well as preserve margin in light of upcoming discount periods.

As discussed herein, an estimate a value for ƒ(I) needs to be determined. In one embodiment, a decomposition of the future expected revenue of the bundle into the sum of the expected future revenues for each of the items in the bundle, namely: (I)=Σ_{iεS}ƒᵢ(Iᵢ). By decomposing the problem in this way, the following linear programming problem may be solved for each SKU in the bundle S separately, and take its objective value to be an approximation for ƒᵢ(Iᵢ). If it is assumed that discount prices are being considered as belonging to a discrete set or price ladder defined by p(t)=(p₁(t), . . . , pₘ(t)); then we introduce (α₁(t), . . . , αₘ(t)) to be convex combinations of the demand Dᵢ(p(t)). [symbol] The demand is the predicted future expected demand overall customer types in the future based on the current data.

Thus the α values are the decision variables, in other words the binary coefficients for each choice of price in the discrete price ladder at every future time period. Then for each item i in the bundle S, the following linear optimization problem may be solved:

$${ax}_{{α}_{m} ( t )} {\sum }_{t} ( {\sum }_{i} {D}_{i} ( p ( t ) ) \cdot {p}_{i} ( t ) \cdot {α}_{m} ( t ) )$$

$$subject o {\sum }_{t} {D}_{i} ( p ( t ) ) \cdot {α}_{m} ( t ) \leq {I}_{i} m$$

$${\sum }_{m} {α}_{m} ( t ) = 1 t$$

$${α}_{m} ( t ) ∈ \{ 0 , 1 \}$$

The above formulation presents a linear programming approach to finding the value for each individual ƒᵢ(Iᵢ) using the additive decomposition. However, due to the fact that this formulation requires many future periods of determination, this embodiment may not provide a solution in the desired a computational timeframe, such as real-time or near real-time recommendations are made during an online browsing session. It should be appreciated that this approach is not limited to the above way of estimating the ƒ function.

By performing the price and bundling recommendation model with respect to each item i within the demand group of the product that the consumer is interested in (e.g. viewing a page in an online merchant's website), a profit may be determined for each bundle. These bundles may then be arranged in a ranked list by profit. In one embodiment, the system offers the customer only the recommended bundle (or individual item) that has the highest profit in the ranked list. In other embodiments, the customer may be offered multiple recommended bundles, such as the top three bundles by profit for example. In still other embodiments, the customers may be offered a list of recommended bundles, where the list of recommended bundles is determined by comparing the ranked list to a threshold and those bundles having a profit above a threshold are included in the list.

Technical effects and benefits of some embodiments include providing a system and method for providing recommended bundles of items at a discounted price to a consumer who is interested in an item on a online merchant's webpage. Technical effects and benefits further include using both static and dynamic parameters from a variety of data sources that provide for personalized purchase probabilities and an inventory expected profit-to-go estimate as a function of profit and inventory balance.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method comprising:
determining, by a computing device of a kiosk positioned in a physical retail location, an interest in an initial product by a consumer;
identifying, by the computing device of the kiosk, a demand group based on the initial product, wherein the identifying of the demand group includes identifying products frequently purchased together based on historical transactions, contextual information and in-session information, and the in-session information corresponds to a duration of time that the consumer has spent on a product page;
determining, by the computing device of the kiosk, a purchase probability for the consumer to purchase the initial product;
determining, by the computing device of the kiosk, an inventory expected profit-to-go value for the initial product;
determining, by the computing device of the kiosk, at least one additional product from the demand group based at least in part on the purchase probability and the inventory expected profit-to-go value, the inventory expected profit-to-go value being based at least in part on a current inventory state of the initial product and the at least one additional product; and
transmitting, by the computing device of the kiosk, a signal to the consumer, the signal including at least one additional product and a price for a bundle containing both the initial product and the at least one additional product.

2. (canceled)

3. The method of claim 1 wherein the contextual information includes a consumer demographics, a consumer social media activity or geographic location.

4. The method of claim 1 wherein the purchase probability is based on demographic information, geographic location data, loyalty information, and historical preferences.

5. The method of claim 4 further comprising determining a confidence parameter based on a purchase history, an in-session information and a contextual information.

6. The method of claim 1 wherein the determining at least one additional product further comprises:
determining with the computing device an expected first profit for a combination of the initial product and the at least one additional product;
determining with the computing device an expected second profit for a remaining plurality of products in the demand group; and
determining with the computing device a current inventory-at-risk estimation.

7. The method of claim 6 wherein the determining at least one additional product is based at least in part on a total expected profit from a bundle offer, based at least in part on a value of the current inventory-at-risk estimation.

8. The method of claim 6 wherein a total expected profit includes three sets of terms, each containing the current inventory-at-risk estimation having parameter values that are determined a periodic basis, each of the three sets of terms defining one of a scenario that includes when the consumer buys the bundle, when the consumer only buys only individual items in the bundle, or the consumer buys nothing at all.

9. The method of claim 8 wherein for each of the expected first profit, the expected second profit and the total expected profit is determined in substantially real-time based on determining the interest in the initial product by the consumer.

10. A system comprising:
a memory having computer readable instructions; and
one or more processors for executing the computer readable instructions, the computer readable instructions comprising:
determining an interest in an initial product by a consumer;
identifying a demand group based on the initial product, wherein the identifying of the demand group includes identifying products frequently purchased together based on historical transactions, contextual information and in-session information, and the in-session information corresponds to a duration of time that the consumer has spend on a product page;
determining a purchase probability for the consumer to purchase the initial product;
determining at least one additional product from the demand group to offer in a personalized bundle based at least in part on the purchase probability and context;
determining an inventory expected profit-to-go value for the personalized bundle;
determining a personalized price based on the purchase probability, a contextual information, and the inventory expected profit-to-go value; and
transmitting a signal to the consumer, the signal including the personalized bundle that includes the initial product, the at least one additional product, and a discounted price for purchasing the personalized bundle, wherein the system corresponds to a computing device of a kiosk positioned in a physical retail location.

11. (canceled)

12. The system of claim 10 wherein the purchase probability is based on a consumer demographic information, a consumer geographic location information, a consumer loyalty information, and a predetermined consumer preferences.

13. The system of claim 12 wherein the computer readable instructions further comprise determining a confidence parameter based on the purchase probability, a purchase history, an in-session information and a contextual information.

14. The system of claim 10 wherein the determining of at least one additional product further comprises:
determining an expected first profit for the personalized bundle including of the initial product and at least one additional product from the demand group;
determining an expected second profit for a remaining plurality of products in the demand group; and
determining a value of a current inventory-at-risk.

15. The system of claim 14 wherein the determining of at least one additional product for personalized bundling is based at least in part on a total expected profit, including the value of the current inventory-at-risk.

16. The system of claim 14 wherein a total expected profit includes three sets of terms, each containing the current inventory-at-risk having parameter values that are determined on a periodic basis.

17. The system of claim 16 wherein the each of the expected first profit, the expected second profit and the total expected profit is determined in substantially real-time based on determining the interest in the initial product by the consumer.

18. A computer program product for determining a personalized bundle offer for a consumer, consisting of a combination of products, the computer program product comprising a computer readable storage medium having program instructions embodied therewith, the program instructions executable by a processor to cause the processor to perform:
determining, by a kiosk positioned in a physical retail location, an interest in an initial product by the consumer;
identifying, by the kiosk, a demand group based on the initial product, wherein the identifying of the demand group includes identifying products frequently purchased together based on historical transactions, contextual information and in-session information, and the in-session information corresponds to a duration of time that the consumer has spent on a product page;
determining, by the kiosk, a purchase probability for the consumer to purchase the initial product;
determining, by the kiosk, at least one additional product from the demand group to offer in a personalized bundle based at least in part on the purchase probability and context;
determining, by the kiosk, an inventory expected profit-to-go value for the personalized bundle;
determining, by the kiosk, a personalized price based on the purchase probability, a contextual information, and the inventory expected profit-to-go value; and
transmitting, by the kiosk, a signal to the consumer, the signal including the personalized bundle that includes the initial product, the at least one additional product, and a discounted price for purchasing the personalized bundle.

19. The computer program product of claim 18 wherein the determining at least one additional product further comprises:
determining an expected first profit for the personalized bundle including of the initial product and at least one additional product from the demand group;
determining an expected second profit for a remaining plurality of products in the demand group; and
determining a value of a current inventory-at-risk.

20. The computer program product of claim 19 wherein:
the determining at least one additional product is based at least in part on a total expected profit from a bundle offer, based at least in part on the value of the current inventory-at-risk; and
the total expected profit includes three sets of terms, each containing the current inventory-at-risk having parameter values that are determined on a periodic basis, the each of the expected first profit, the expected second profit and the total expected profit is determined in substantially real-time based on determining the interest in the initial product by the consumer.
